(19) United States
(12) Patent Application Publication
(10) Pub. No.: US 2005/0045702 A1
(43) Pub. Date: Mar. 3, 2005

(54) Thermoelectric modules and methods of manufacture

(76) Inventors: William Freeman, Castro Valley, CA (US); Hong Jin Jiang, Singapore (SG)

Correspondence Address: R. BURNS ISRAELSEN;WORKMAN NYDEGGER, 1000 Eagle Gate Tower, 60 East South Temple, Salt Lake City, UT, 84111, US

(21) Appl. No.: 10/738,695

(22) Filed: Dec. 17, 2003

Related U.S. Application Data
(60) Provisional application No. 60/498,943, filed on Aug. 29, 2003.

(51) Int. Cl. B23K 31/02

(52) U.S. Cl. 228/254; 228/180.21

(57) ABSTRACT

A method of and intermediate structures for manufacturing a thermoelectric module are disclosed. A first and second intermediate structure are each formed by providing a substrate, bonding a wafer to the substrate, and removing a portion of the wafer to leave behind a plurality of thermoelectric elements extending outwardly from the substrate. The portion of the wafer can be removed by precision cutting methods such as, but not limited to, slicing, dicing, laser ablation, and the like. The substrate has a metallized pattern formed thereon. The wafers of the first and second intermediate structures are formed from different conductive materials. N-type and P-type bismuth telluride are examples of thermoelectric materials having different conductivities. The first intermediate structure and second intermediate structure are aligned, brought adjacent each other, and bonded together such that the elements are in electrical communication appropriate to thermoelectric module function.

### CROSS-REFERENCE TO RELATED APPLICATIONS

This application claims priority to and benefit from U.S. Provisional Patent Application Ser. No. 60/498,943, filed Aug. 29, 2003 and entitled “Thermoelectric Modules and Methods of Manufacture,” which application is incorporated by reference herein in its entirety.

### BACKGROUND OF THE INVENTION

1. The Field of the Invention

The present invention relates to thermoelectric modules. Specifically, the present invention relates to methods of manufacturing thermoelectric modules and resulting thermoelectric modules that are more efficient than conventional thermoelectric modules.

2. The Relevant Technology

Thermoelectric modules, also known as thermoelectric coolers (TECs) or Peltier coolers, are small, light, semiconductor devices that are able to operate as both a oz cooler (i.e., heat pump) and/or a heater. Conventional thermoelectric modules usually include a top substrate and a bottom substrate between which are disposed thermoelectric elements constructed of thermoelectric material. As used herein, the term “thermoelectric material” refers to any material that allows both thermal conduction and electrical conduction, and a Seebeck coefficient greater than 50 μV/°K. A conventional thermoelectric module includes a couple or a pair of thermoelectric elements. The elements in each couple or pair typically have dissimilar conduction characteristics. Usually, the thermoelectric material is a material that is doped to form N-type and P-type elements. The N-type elements contain an excess of electrons while the P-type cooling elements contain a deficiency of electrons. Thus, a thermoelectric couple would include one N-type and one P-type element. Usually, more than one pair of elements is desired to distribute the cooling effect about the area of the thermoelectric module.

When used as a heat pump, thermoelectric modules operate on the Peltier effect. The Peltier effect refers to the general proposition that when an electric current passes through two dissimilar conductors, a temperature differential is created. The temperature differential causes heat to move from one end to the other, forming a “hot face” on one substrate and “cold face” on the opposing substrate.

The effectiveness of a thermoelectric module can be measured in several ways: The most important specifications for a thermoelectric module are the maximum current (Iₘₐₓ), the maximum heat that can be transported (Qₘₐₓ), the maximum voltage (Vₘₐₓ) (which is related to the internal resistance of the thermoelectric module), and the maximum temperature difference that can be developed across the thermoelectric module at near zero heat load (ΔTₘₐₓ).

In addition, thermoelectric modules are measured by a Coefficient of Operating Performance (COP), and a measurement of merit for cooling devices (ZT). The COP is defined as the amount of heat pumped divided by the amount of power supplied to the thermoelectric module. The COP rarely goes above 50% for single stage thermoelectric modules, and for multistage thermoelectric modules is frequently only a few percent. This figure of merit does not tell anything about the temperature differential (ΔT) between the hot and cold side of the thermoelectric module. The possible range of ZT is from 0 to 4. For a compressor driven equipment like a refrigerator, the ZT is around 4. However, for miniature thermoelectric modules, most have a ZT in the range of 0.6 to 1.2.

In further detail, the usual definition of the dimensionless figure of merit is ZT=α²T/(ρK_{T}), where α is the Seebeck coefficient (sometimes referred to as the thermopower), T is the absolute temperature, ρ is the electrical resistivity, and K_{T} is the total thermal conductivity. KT can be further separated into the lattice and electrical contributions to the thermal conductivity, i.e., K_{T}=K_{L}+Kₑ. Thus, ZT can be rewritten as Q/K_{T}=αIT_{c}/K_{T}, which can be interpreted as the heat pumped at a particular current over the thermal conductivity at that temperature. Both the components of thermal conductivity, i.e., the lattice component and an electronic component, have some temperature dependence. If the current is rewritten as I=α/p then upon substituting for I in the above equation one gets the standard ZT formula. So ZT can be interpreted as the ratio of the heat pumped to the thermal conductance of the elements doing the pumping.

Clearly, increasing the heat pumped, generally increasing the Seebeck coefficient α or decreasing the thermal conductivity of the elements increases ZT, so ZT is a very reasonable measure of how good the thermoelectric material is for making thermoelectric modules. For those who look carefully at this argument it will be apparent that there has been a bit of deception. The units of α are V/°K and the units of ρ are Ω−m, so the ratio is V/Ω−m−°K or A/m−°K, not exactly I. That is, thermal conductance instead of thermal conductivity and resistance of the thermoelectric element should technically be used. However, this is not important both for simplicity and because it is easy to show that ZT is in fact unitless. In terms of dimensions only ZT=(V/K)²K/[Ω−m(W/m−°K)]=V²/Ω−W=V(V/Q)/W=VI/W=1.

The density of the thermoelectric pairs and the size and shape of the thermoelectric pairs in a thermoelectric module impact the efficiency of the thermoelectric module. The two most important factors are the thermal resistance of the thermoelectric elements and the Seebeck coefficient, α, which determines the amount of heat that the thermoelectric element can transport at a given current. According to the Ioffe equation the heat pumping due to the Peltier effect is given by Q_{Sb}=2NαIT_{c}, where N is the number of thermoelectric couples (pairs of elements), I is the current passing through the elements and T_{c} is the cold side temperature.

In order to get greater thermal isolation between the hot and cold surfaces of the thermoelectric module, one would be inclined to increase the height of the thermoelectric elements. However, as the height of the thermoelectric module increases, so does the internal resistance created therein. Increased resistance generates internal Joule heat, I²R heat. This internally generated heat is frequently comparable and sometimes greater than the amount of external heat being pumped by the thermoelectric elements. The thermoelectric module must pump both the externally supplied heat and the internally generated heat. However, as the height of the thermoelectric elements decreases (thus decreasing resistance), this results in dissipating heat in the power supply. Thus, the height of the thermoelectric element must balance these competing sources of inefficiency.

One way to balance these needs is to reduce the size of the thermoelectric elements and increase their density in a thermoelectric cooler module. This increases the total resistance, while, reducing the individual resistance experience in each thermoelectric element. In most cases the optimal shape for the thermoelectric elements is nearly cubic, i.e., as tall as it is wide. In addition, a more densely populated thermoelectric module will distribute the cooling more evenly. Thus, reducing the size of the thermoelectric elements and increasing their density in the thermoelectric module allows the thermoelectric module to be efficiently powered.

The thermoelectric elements have conventionally been made using mechanical manufacturing techniques. The thermoelectric material is usually a crystalline material, such as, bismuth telluride. Bismuth telluride can be produced by directional crystallization from a melt; usually by vertical Bridgeman techniques. When manufactured as such, the thermoelectric material is fabricated in ingot or boule form, which is a cast of the thermoelectric material solidified from a melt. The thermoelectric material can be doped at the same time as forming the crystal, thus forming N-type and P-type ingots. The ingot is then sliced into wafers of desired thickness. After the wafer's surfaces have been properly prepared, the wafer is then diced into discrete blocks or elements. Discrete thermoelectric elements may also be formed from pressed powder metallurgy processes. This produces N-type and P-type thermoelectric elements which are then arranged in an organized manner onto a substrate. A machine and/or operator then places and attaches the N-type and P-type elements in an arranged pattern on one substrate. Next, the opposing substrate is bonded on top of the arranged elements.

Mechanical manufacturing methods are not particularly efficient for a number of reasons. Generally, as the size of the thermoelectric module decreases, so will the size of the elements. Because of the small size of the individual thermoelectric elements, they become difficult to handle. Manipulation of these tiny elements, even by machine, presents design considerations and limitations. Furthermore, designing and manufacturing machines to handle small thermoelectric elements becomes costlier as the elements become smaller.

The best electrical and thermal conductivity of some crystal elements, such as bismuth telluride, is often dependent on a certain crystal orientation. Bismuth telluride, for example, should be placed in a direction with the C axis perpendicular to the substrate to produce the best results. Bismuth telluride has a structure not unlike mica. Therefore, if the bismuth telluride elements are attached such that the weakly bonded planes are parallel to the hot and/or cold faces of the thermoelectric module, then the thermoelectric module can easily fall apart. However, if mounted so that the planes are perpendicular to the faces of the thermoelectric module, than then the assembly is quite strong.

However, the manual and/or automatic placing of elements on the substrate in the method of manufacture described above requires additional steps and/or machinery having the required sensory ability to ensure that all of the elements are placed on the substrate in the desired crystal orientation. It is sometimes the case that the manufacturing process does not always produce a thermoelectric module in which all of the elements are placed in the desired or most effective crystal orientation on the substrate

Some manufacturers have moved to wafer-manufacturing techniques using chemical processes/thin film techniques instead of mechanical manufacturing techniques. With reference to FIGS. 1A through 1D, a thermoelectric module is illustrated being formed using thin film techniques. Thin film techniques include metalorganic chemical vapor deposition (MOCVD), chemical vapor deposition (CVD), molecular beam epitaxy (MBE) and other epitaxial/non-epitaxial processes. As shown in FIG. 1A, thin film techniques involves forming by growing or depositing one or more thin layers of thermoelectric material on a substrate 3 so that a thermoelectric layer 2 of sufficient thickness is formed. The substrate provides structural strength to the thermoelectric layer 2. The thermoelectric material can be shaped into smaller element portions while on the substrate.

As depicted in FIG. 1B, the thermoelectric elements formed on the substrate 3 are then bonded to a metallized header or metallized substrate 6 which forms one of the cold face or hot face of the thermoelectric module. FIG. 1C illustrates that the original depositing substrate (substrate 3 in FIGS. 1A and 1b) is then removed by etching or by another known removal process. As illustrated in FIG. 1D, the thermoelectric N-type and P-type elements in the thermoelectric layer 2 can be further manufactured into smaller thermoelectric elements using laser ablation or other technique. These processes produce values of ZT between 1.3 and as high as 2.5.

Disadvantageously, the thin film or deposition techniques require the use of an additional step on which the thermoelectric elements are formed on a separate substrate and then transferred to a final substrate. This requires an additional removal step during manufacture of the thermoelectric module. In addition, the back-conduction of heat through the film limits the usefulness of the thermoelectric device.

### BRIEF SUMMARY OF THE INVENTION

The present invention is directed to thermoelectric modules and methods of manufacturing thermoelectric modules. Embodiments of the invention are directed to manufacturing miniature thermoelectric modules having total areas of only a few millimeters. It is particularly in these miniature embodiments that the methods of this invention are most cost-effective and practical. However, embodiments of the present invention may also be applicable in other applications outside miniature-scale field.

The thermoelectric modules of the present invention include one or more pairs or couples of thermoelectric elements. Each pair of elements is connected electrically in series and thermally in parallel. The thermoelectric elements are constructed of thermoelectric material. As used herein, the term “thermoelectric material” refers to any material which allows both thermal conduction and electrical conduction, and a Seebeck coefficient greater than 50 μV/°K.

Each thermoelectric element of each pair typically has different conductive characteristics. This is achieved, in one embodiment, by including a P-type element and an N-type element in each pair. Another method of forming elements having different electric conductivities is to form one element being composed of one thermoelectric material and the other element being composed of an entirely different thermoelectric material.

The elements of each pair are disposed between two substrates. One of the substrates forms a “cold end” or “cold face,” and the other substrate forms a “hot end” or “hot face.” The substrates serve to provide mechanical structure to the thermoelectric module, but also to insulate the elements electrically, one from the other, and from external mounting surfaces. The substrates may be constructed of any material which provides sufficient thermal conductivity and is sufficiently dielectric that no significant electrical conduction occurs between the elements and/or other external objects.

The substrates include a metallized pattern on one surface thereof which contacts the elements of the thermoelectric module. The metallized pattern forms electrical interconnects between the cold ends of the elements of the same couple and also forms interconnects at the hot ends between elements of different couples so that all of the elements are placed in electrical communication. An electric connect is placed at terminal points of the metallized pattern to be connected to a low voltage DC power source to form an electric circuit. In one embodiment, the metallized pattern is formed so that when the thermoelectric elements are connected thereto, the thermoelectric elements are placed in series electrically and in parallel thermally.

In operation, the cold face of the thermoelectric module is placed adjacent to an object to be cooled. The hot face of the thermoelectric module is placed adjacent a heat sink which transmits heat to the environment. A power source applies electric current to the electric circuit formed by the metallized pattern and thermoelectric elements. The extra electrons in the N-type elements (in the embodiment where N-type and P-type materials form the different thermoelectric materials) together with the holes created by the deficiency of electrons in the lattice structure of the P-type elements, carry heat energy through the elements. The heat is absorbed by the electron movement, transported through the TEC element and expelled at the hot face. The heat is transferred from the substrate to the heat sink and transferred to the environment. This phenomenon may be reversed by changing the polarity of the applied DC voltage to cause heat to move in the opposite direction, creating a heater instead of a cooler. Since the device is symmetrical, reversing the current reverses the direction the heat is pumped.

The elements of the thermoelectric module may be arranged in various configurations. In one embodiment, elements are arranged in alternating fashion. For example, the elements can be alternated in a checkerboard fashion in which each element is surrounded by elements of a different conductive material on each side. In another embodiments, the elements may be arranged in rows where each row contains a different thermo conductive material. The metallized pattern formed on the substrates is patterned such that any arrangement of element configurations are possible.

A thermoelectric module is formed, for example, from two intermediate structures. One of the intermediate structures has thermoelectric elements having one conductive characteristic (e.g., N-type elements) and the other intermediate structure has thermoelectric elements having different conductive characteristics (e.g., P-type elements). The two intermediate structures are then bonded together.

In one embodiment, each intermediate structure includes a substrate that has a metallized pattern of conductive metal formed thereon. Alternatively, the metallized pattern could be formed while bonding the thermoelectric material to the substrate. A wafer of the thermoelectric material (e.g., N-type or P-type) is bonded to the substrate. The wafer can be bonded by brazing or soldering the wafer to the substrate. In one embodiment, the metallized pattern can be formed during the brazing or soldering

The eventual positions of the elements is predetermined and identified. The material which forms the N-type elements remains on the substrate while the remaining unnecessary or superfluous material will be removed. The unnecessary material is removed by any of several methods. In one embodiment, a precision cutting method is used. Other methods include, but are not limited to, dicing, slicing, laser ablation, dissolution, abrasion, and the like. The foregoing process thus form an intermediate structure having a plurality of elements disposed thereon and extending outwardly from the substrate. The elements are spaced apart such that, when combined with the a second intermediate structure of the thermoelectric module, the elements of the first intermediate structure are be properly placed in the predetermined configuration with respect to the elements of the second intermediate structure. The first intermediate structure may have P-type elements while the second intermediate structure may have N-type elements.

The first and second intermediate structures are then bonded together using a bonding process such as, but not limited to, brazing, soldering, epoxy, and the like. In one embodiment, the N-type and P-type elements are electrically connected during the bonding process. Alternatively, an additional bonding process can be used to place the elements in electrical communication such as, but not limited to, a reflow process.

Advantageously, the thermoelectric elements can be formed extremely small, thus producing extremely small thermoelectric modules. Another advantage is that the thermoelectric elements can be formed on the substrate in the most effective orientation. That is, the wafer of the thermoelectric material is placed on the substrate in the correct crystal orientation. Thus, all of the thermoelectric elements formed from the wafer have the correct orientation. In another embodiment, a cascade or stacked thermoelectric module may be formed from a first, second and third intermediate structure.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A-1D illustrate a conventional method of manufacturing a thermoelectric module using thin film techniques;

FIG. 2 illustrates a plan view of an embodiment of a thermoelectric module according to the present invention;

FIG. 3 illustrates a cross-sectional view of the embodiment of FIG. 2;

FIGS. 4 and 5 illustrate the top and bottom substrates for the embodiment of FIG. 3 having metallized patterns formed thereon to create the electrical interconnects for the thermoelectric elements;

FIG. 6 illustrates another embodiment of the cross-sectional view of the embodiment of FIG. 2;

FIG. 7 illustrates one embodiment of manufacturing an intermediate structure having thermoelectric elements;

FIG. 8 illustrates one embodiment of manufacturing another intermediate structure having thermoelectric elements that are dissimilar to the thermoelectric elements of the intermediate structure illustrated in FIG. 7;

FIG. 9 illustrate one embodiment of manufacturing a thermoelectric module;

FIG. 10 illustrates one embodiment of a cascade thermoelectric module; and

FIG. 11 illustrates one embodiment of an expanded perspective view of a cascade thermoelectric module.

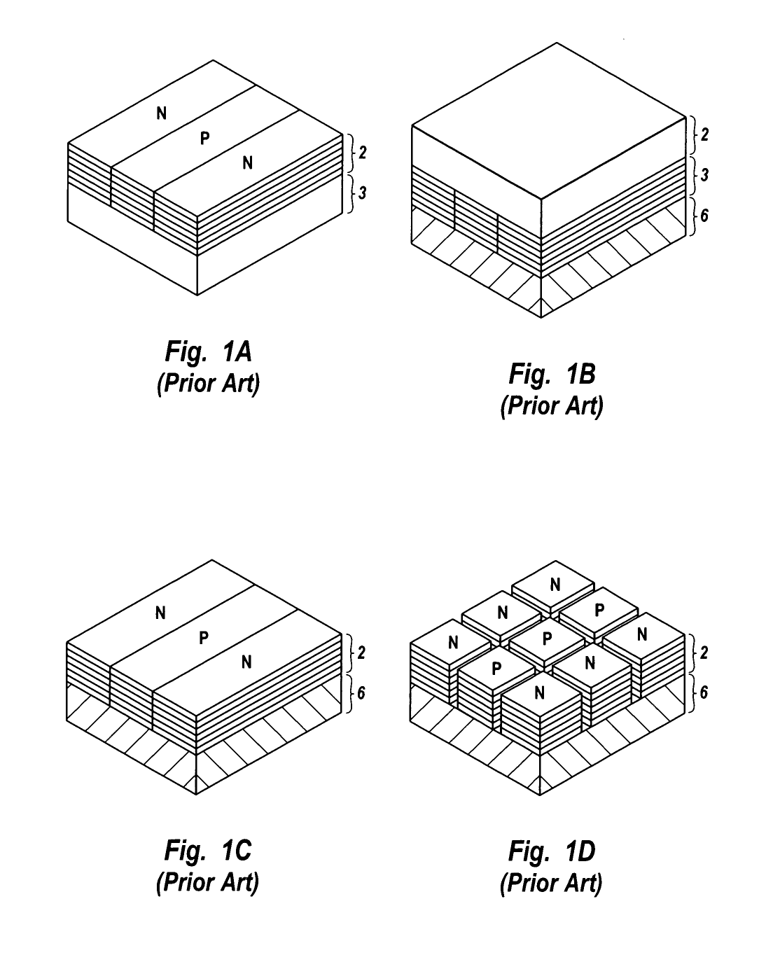

### DETAILED DESCRIPTION OF THE PREFERRED EMBODIMENTS

The present invention is directed to thermoelectric modules and improved methods of manufacturing thermoelectric modules. The ability of thermoelectric modules to cool or heat an object makes them useful in a variety of applications such as, but not limited to military, medical, industrial, consumer, scientific/laboratory, and telecommunications applications. Uses range from simple food and beverage coolers for an afternoon picnic to extremely sophisticated temperature control systems in missiles and space vehicles or cooling the infrared sensor array in night vision displays.

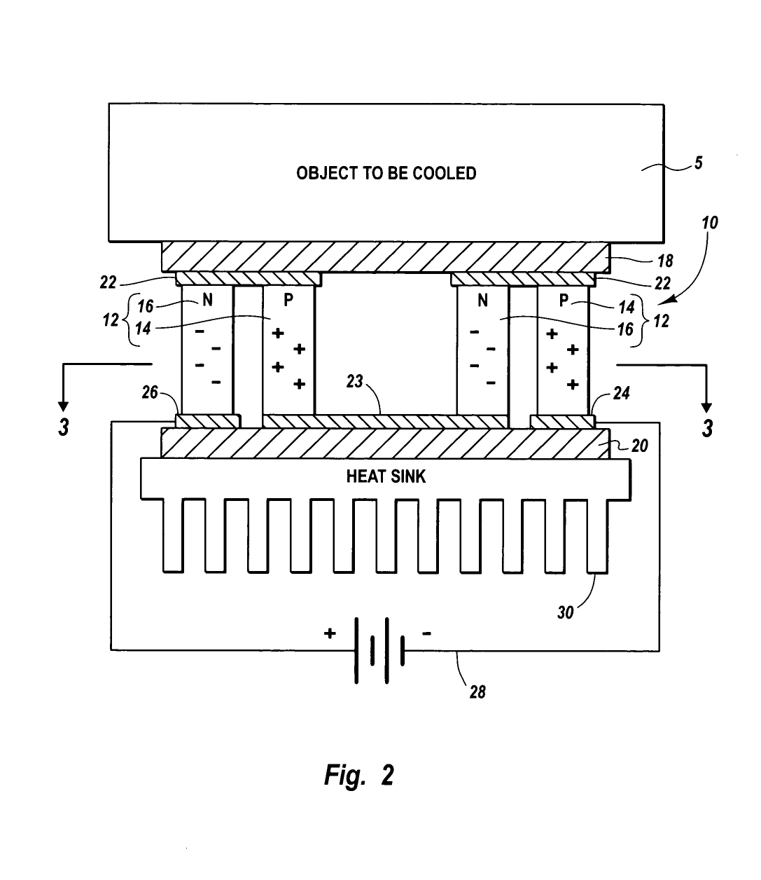

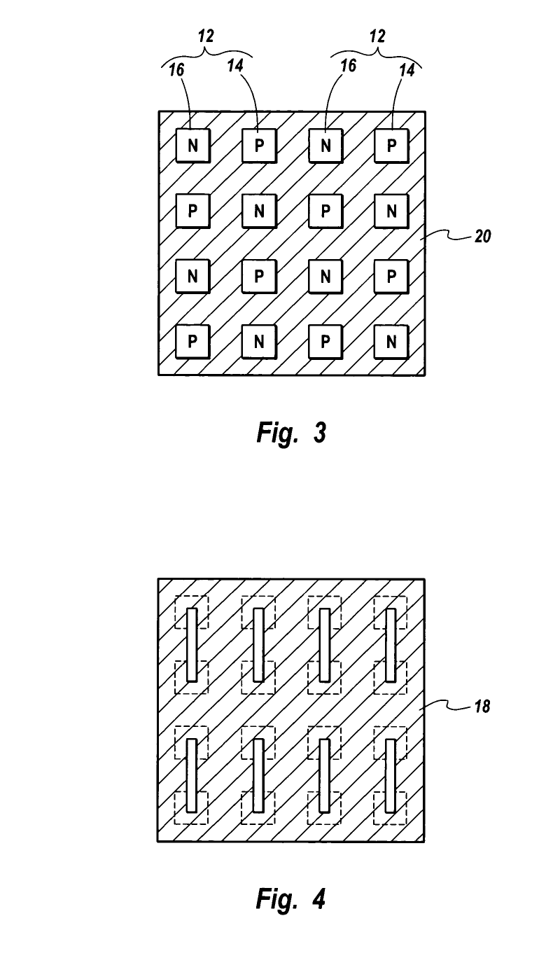

FIG. 2 depicts one embodiment of a thermoelectric module 10. Thermoelectric module 10 includes one or more couples or pairs 12 of thermoelectric elements 14, 16. Elements 14, 16 are connected electrically in series and thermally in parallel and are constructed of thermoelectric material. However, elements 14, 16 may be connected electrically in a series/parallel combination in very special cases. As used herein, the term “thermoelectric material” refers to any material which allows both thermal conduction and electrical conduction and has a Seebeck coefficient greater than 50 μV/°K. Typically, the thermoelectric elements 14, 16 for each pair 12 have different conductive characteristics.

One method of forming different conductive characteristics within the thermoelectric material is to form one element 14 being electron-rich and the other element 16 being electron-poor. The deficiency of the electron-poor element 16 will drive the movement of electrons from one element 14 to the element 16, and, at the same time, drive heat conduction from one end of the thermoelectric module to the other. Electron-rich and electron-poor thermoelectric materials can be formed by doping a material to form N-type and P-type material. The N-type element is doped so that it has an excess of electrons and the P-type element is doped so that it has a deficiency of electrons. Thus, in one embodiment, each pair 12 of thermoelectric elements includes a P-type element 14 and an N-type element 16.

Other methods of forming different conductive characteristics in the thermoelectric elements may also be used. The element 14 may be composed of different materials than element 16. For example, element 14 may be constructed of bismuth telluride while element 16 may be formed from lead telluride. As such, elements 14, 16 will have different conductive characteristics because of the different chemical nature of the elements.

The thermoelectric material is generally a crystalline material. The thermoelectric materials of the present invention contemplate any existing thermoelectric materials and any improved thermoelectric material that may be conceived of hereafter. In one embodiment, the thermoelectric material is a bismuth telluride (Bi₂Te₃) alloy that has been suitably doped to provide thermoelectric elements having distinct N-type and P-type characteristics. Other suitable thermoelectric materials include, but are not limited to, lead telluride (PbTe), ceramic germanium (SiGe), and bismuth-antimony (Bi—Sb) alloys.

Elements 14, 16 are typically disposed between and mounted to two substrates 18, 20. In this example, the substrates 18 is referred to as the “cold end” or “cold face” and the substrate 20 is referred to as the “hot end” or “hot face.” The terms “cold face” and “hot face” refer to the situation where thermoelectric module 10 operates as a heat pump. However, where thermoelectric module 10 functions as a heater (i.e., by reversing the direction of the current), it will be appreciated that the “cold face” and the “hot face” would be reversed. In this embodiment, the substrates 18, 20 provide mechanical structure to the module 10, but also insulate elements 12 electrically one from the other and from external mounting surfaces. The substrate 18 that serves as the “cold face” is preferably placed adjacent to an object 5 which is to be cooled.

The substrates 18, 20 may be constructed of any material which provides sufficient thermal conductivity, mechanical stability, and electrical isolation between the object 5 to be cooled and heat sink 30. In addition, substrates 18, 20 are usually electrically insulative (dielectric) to other external objects. In one embodiment, the substrates 18, 20 are a ceramic material such as, but not limited to, aluminum oxide (Al₂O₃), aluminum nitride (AIN), or beryllium oxide (BeO). Substrates 18, 20 could also be a glass-ceramic material. In another embodiment, substrates 18, 20 could be a silicon-based material. In other embodiments, the substrate is a composite or multilayer material.

An electrical interconnect 22 is placed at the “cold ends” of elements 14, 16 to connect each pair 12 and place the elements of the couple in electrical communication with each other. At their “hot ends” an interconnect 23 is placed between adjacent P-type and N-type elements 14, 16 which are not part of the same pair. Connects 24, 26 are placed on terminal P-type and N-type elements at the “hot end.” Electrical connects 24, 26 place elements 14, 16 in electrical communication with a low voltage DC power source 28. As such, electrical current is able to flow in a circuit through all the P-type and N-type elements of the thermoelectric module 10. Interconnects 22, 23, 24 and 26 are formed from a metallization process in which a conductive metal pattern is printed or formed on substrates 18, 20. In one embodiment, the conductive metal is copper. The substrate 20 that serves as the “hot face” is usually placed adjacent to a heat sink 30.

In operation, power source 28 applies current to elements 14, 16 in each pair 12 of the module 10 because the metallized pattern on the substrates causes all of the pairs to be connected in series. The extra electrons in the N-type elements 16 together with the “holes” created by the deficiency of electrons in the lattice structure of the P-type elements 14 carry heat energy through elements 14, 16. Heat is absorbed by the conduction of electrons in the N dope crystal, which heat is moved through the material and expelled at the hot face substrate 20. The electron dropping into a hole in the P-type element releases energy in the form of heat and at the other end absorbs energy in order to be liberated from the hole. So the heat transport mechanisms are similar but not identical for the two types of elements. The heat is transferred from substrate 20 to heat sink 30, transferring the heat from the thermoelectric module 10 to the environment. As such, substrate 18 is cooled while the other substrate 20 is heated. This phenomenon may be reversed by changing the polarity of the applied DC voltage to cause heat to move in the opposite direction, thus creating a heater instead of a cooler.

The heat flux being pumped through the elements 14, 16 is proportional to the magnitude of the applied DC electric current. (This proportionality factor is called the Seebeck coefficient. The important relationship for the amount of heat pumped at the cold side of the thermoelectric module is Q_{Sb}=2NαIT_{c}, where N is the number of thermoelectric couples, α is the Seebeck coefficient, I is the current through the elements, which is the same for each element since they are connected in series, and T_{c} is the temperature at the cold side of the thermoelectric module.) Thus, by varying the input current from zero to maximum, it is possible to adjust and control the heat flow and thus the temperature of the object 5 to be cooled. Because thermoelectric modules are operates using highly controlled voltage, the thermoelectric module can be used for precise temperature control applications. In addition, the solid-state nature of thermoelectric module 10 has no moving parts and is quiet. The only movement is due to thermal expansion or contraction of the thermoelectric elements. The coefficient of thermal expansion (CTE) of the outer surfaces of the thermoelectric elements is generally so small, generally <6 ppm/° C., that for most practical purposes, the CTE can be disregarded.

Typically, a thermoelectric module includes more than one pair of thermoelectric elements. Generally, it is most efficient to arrange the N-type and P-type elements in an alternating configuration, at least in one dimension. FIG. 2 illustrates that from one side view, the N-type elements 14 and P-type elements 16 are disposed in an alternating fashion. As shown in FIGS. 3 and 6, this may be accomplished in at least two ways. In FIG. 3, the elements of the pairs are generally arranged on a thermoelectric substrate in a checkerboard fashion with N-type 14 and P-type elements 16 arranged in an alternating matrix. In FIG. 6, the N-type elements 14 and P-type elements 16 are arranged in alternating rows where any one of the elements is disposed next to both N-type and P-type elements. That is, an N-type or P-type element can be situated next to an N-type element of the same type. Note that in FIGS. 3 and 6, the metallization pattern which connects the elements is not shown to more clearly show the pattern of the elements. Either embodiment shown in FIG. 3 or 6 is feasible, as long as the metallic conductive layers forming the electrical interconnects between the P-type and N-type elements are configured to pair the correct elements.

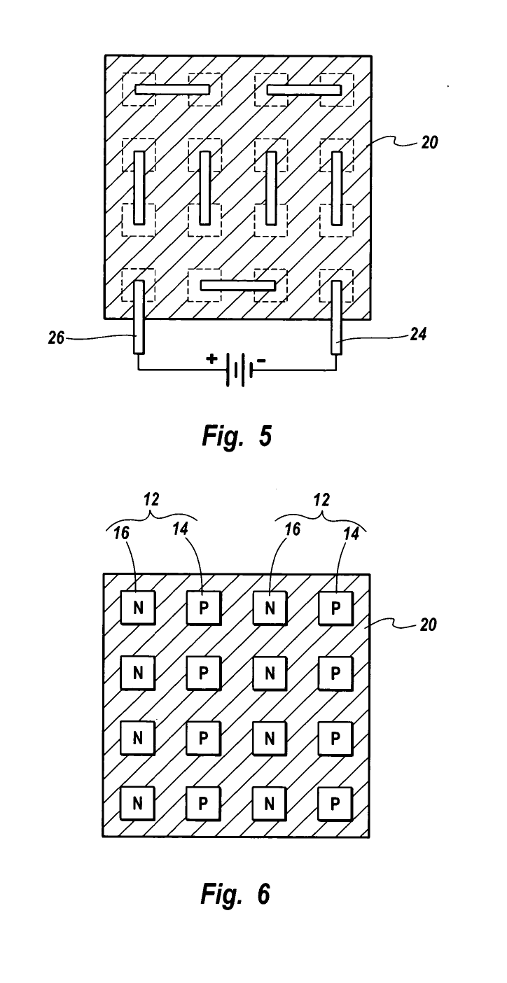

As shown in FIGS. 4 and 5, an exemplary metallizing pattern for the top or “cold face” substrate 18 and the bottom or “hot face” substrate 20 is illustrated. These metallizing patterns correspond to the checkerboard configuration of thermoelectric elements that are shown in FIG. 3. The elements are placed in shadowed lines to indicate which elements are connected by the metallizing pattern. The metallizing patterns are designed or configured to place all of the N-type and P-type elements of the thermoelectric module 10 in electrical communication. It will be understood that other metallizing patterns may be employed. Similarly, metallizing patterns can be designed for the top and bottom substrates 18, 20 corresponding to the rowed configuration of FIG. 5 as will be understood by those skilled in the art.

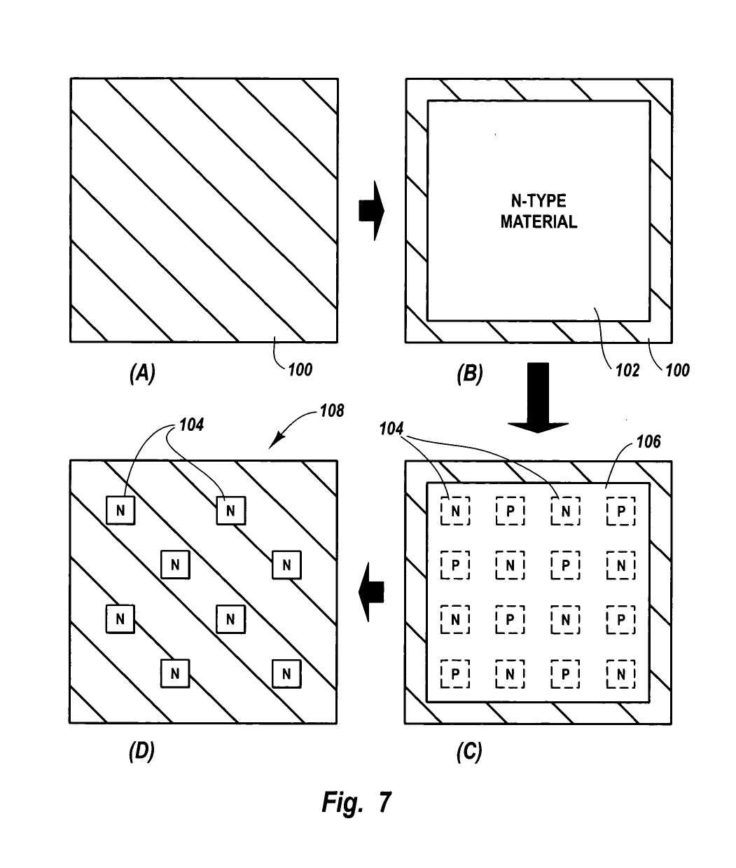

FIGS. 7 through 9 illustrate an exemplary method for forming thermoelectric elements and arranging them in arranged configurations, such as those described above. To construct the thermoelectric elements of the present invention, instead of the thermoelectric elements being discretely formed and then placing them on the substrate, the thermoelectric elements are formed directly on the substrate. The thermoelectric module is formed in two intermediate structures with the P-type elements being formed on one intermediate structure and the N-type elements being formed on the other intermediate structure. The two intermediate structures are then bonded together.

FIGS. 7A through 7D illustrate the manufacturing steps for the first intermediate structure. For purposes of this description, the first intermediate structure will have N-type elements formed thereon. The opposing P-type elements will be formed on the second intermediate structure. However, the first and second intermediate structures are not limited to this configuration.

As shown in FIG. 7A, a first substrate 100 is provided. Preferably, the first substrate 100 is thermally conductive and electrically insulative. Substrate 100 can either be the substrate for the “hot face” or the “cold face” of the thermoelectric module. Although not shown, the substrate 100 may have a metallizing pattern of conductive metal formed thereon. Alternatively, the metallizing pattern could be formed while bonding the thermoelectric material to the substrate, discussed below. The metallizing pattern depends on whether the substrate 100 is intended to be for the “cold face” or “hot face” of the thermoelectric module.

Next, as shown in FIG. 7B, a wafer 102 of N-type material is bonded to the substrate 100. The wafer 102 can be bonded by brazing or soldering the wafer to the substrate 100. Advantageously, the brazing or soldering can be controlled so that it corresponds to the metallized pattern on the substrate. Alternatively, the brazing or soldering step could form the metallizing pattern on the substrate 100 simultaneously with bonding the wafer 102 thereto. The bonding material typically has a melting temperature higher than the maximum temperature that the thermoelectric material will experience so that the thermoelectric elements will remain intact after the thermoelectric module is formed.

Each intermediate structure of the thermoelectric module is formed such that when the intermediate structures are connected, the N-type elements and P-type elements are in the desired arrangement. Thus, as shown in FIG. 7C, the eventual position of the N-type and P-type elements is predetermined and their outlines shown in shadowed lines. Because the wafer 102 constitutes N-type material, only the N-type elements 104 are formed on the intermediate structure. The P-type elements are shown simply to show how the N-type elements are positioned in relation to the P-type elements in the final thermoelectric module. As indicated in FIG. 7C, the material which will eventually form the N-type elements is indicated as numeral 104 while the rest of the material is unnecessary or superfluous and indicated as numeral 106. The N-type elements 104 will remain while the unnecessary material 104 is removed.

As shown in FIG. 7D, the unnecessary material 106 of the wafer 102 is removed by any of several methods. A precision cutting method may be used to form the elements 104. Other methods include, but are not limited to, dicing, slicing, laser ablation, dissolution, abrasion, and the like. These methods may be combined with various forms of isotropic or anisotropic etching to achieve cleaner results with less crystal damage. For relatively thin layers, an etching technique may be the best method. This process thus forms an intermediate structure 108 having a plurality of N-type elements 104 disposed thereon. The N-type elements 104 are spaced apart so that, when combined with the other intermediate structure of the thermoelectric module, the N-type elements 104 will be properly placed in the predetermined configuration with respect to the P-type elements.

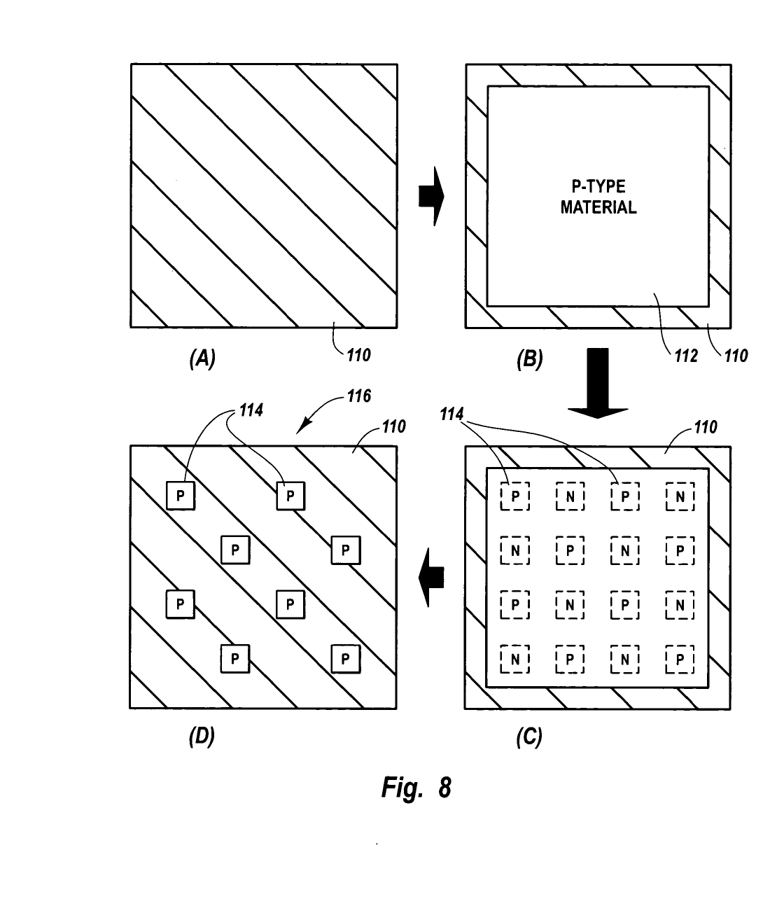

As shown in FIGS. 8A through 8D, the above process steps are repeated using a different conductive material. That is, in the present example, a P-type thermoelectric material is used. A wafer 112 of a P-type material is bonded to a substrate 110. The boundaries of the P-type elements 114 are identified and the unnecessary thermoelectric material removed. A metallic conductive pattern may be formed on the substrate 110 before or simultaneously to bonding the wafer 112 thereto. The steps shown in FIG. 8A through 8D thus form a second intermediate structure 116 having a plurality of P-type elements 114 formed thereon.

Thus, the two intermediate structures 108, 116 are formed with each having half of the required thermoelectric elements of a particular thermoelectric material formed thereon. The location of the N-type elements 104 formed on the first substrate 100 is predetermined to offset those of the P-type elements 114 formed on the second substrate 110.

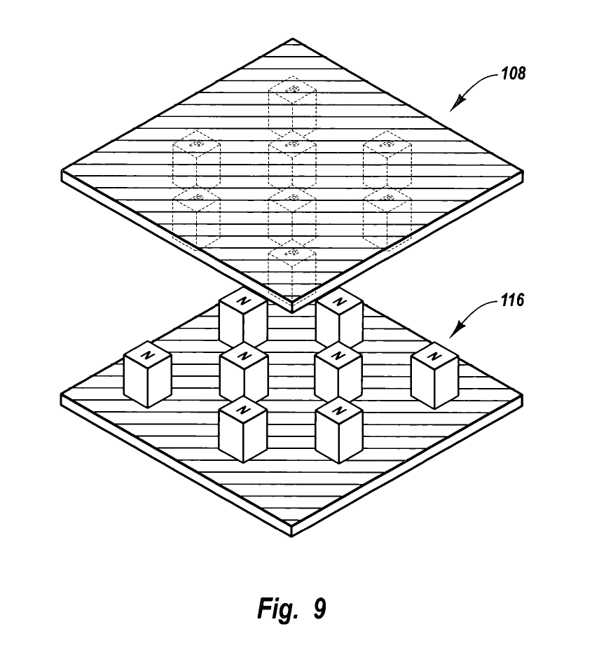

As shown in FIG. 9, the two intermediate structures 108, 110 are then aligned such that their respective thermoelectric elements formed thereon face each other. The intermediate structures 108, 110 are brought near each other until the N-type and P-type elements are placed adjacent their opposing substrate. The thermoelectric elements form pairs of thermoelectric elements as previously described. The intermediate structure 108, 110 are then bonded together placing the N-type and P-type elements in the desired arrangement between substrates 100, 110. A complete thermoelectric module 120 is thus formed. The N-type and P-type elements 104, 112 can be electrically connected to the opposing substrate by a bonding process, such as reflow. Thus, if a reflow step is used, the melting temperature of the bonding material should be higher than the reflow oven, for example greater than 240° C.

The size of the thermoelectric modules of the present invention generally range from about 1 mm to 8 mm in length and width and about 0.2 mm to about 1.2 mm in height. The thermoelectric elements of the present invention may range from about 0.1 mm to about 1 mm in length and width and about 0.1 mm to about 1 mm in height.

One of the advantages of the methods of manufacturing thermoelectric modules according to the present invention is that it eliminates many of the previous limitations that conventional methods had on how small the thermoelectric elements could be formed. Another advantage of the method of the present invention is that it allows the thermoelectric elements to be consistently placed in the most efficient orientation. The orientation of the thermoelectric materials on the substrate will depend on the particular thermoelectric material being used and will be understood by those of skill in the art. Generally, the orientation of the axis of crystal growth with respect to the substrate will depend on a number of factors including, but not limited to, the electrical resistivity and the thermal conductivity of the thermoelectric material. For example, bismuth telluride elements should be placed so that the axis of crystal growth is perpendicular to the ceramic substrate. Bismuth telluride is also a preferred material because it easily cleaves in the desired direction. Thus, a bismuth telluride wafer can be easily sliced from an ingot formed from a bismuth telluride crystal melt such that the wafer has an axis of crystal growth that, when bonded to substrate 100, will be perpendicular thereto. In this manner, all of the elements formed from the wafer 102 have the same crystal orientation.

An additional advantage of the present invention is that the costs of manufacturing thermoelectric modules is greatly reduced by simplifying the process and requiring less manufacturing steps. Note that this method could be considered wasteful of material since more than half of the thermoelectric material is being eliminated. Thus, the approach may be most economically beneficial in the area of miniature thermoelectric modules where the cost of the wasted material is not significant compared with the savings due to ease of manufacture. Advantageously, this cost savings transfers to the device in which the thermoelectric module is applied.

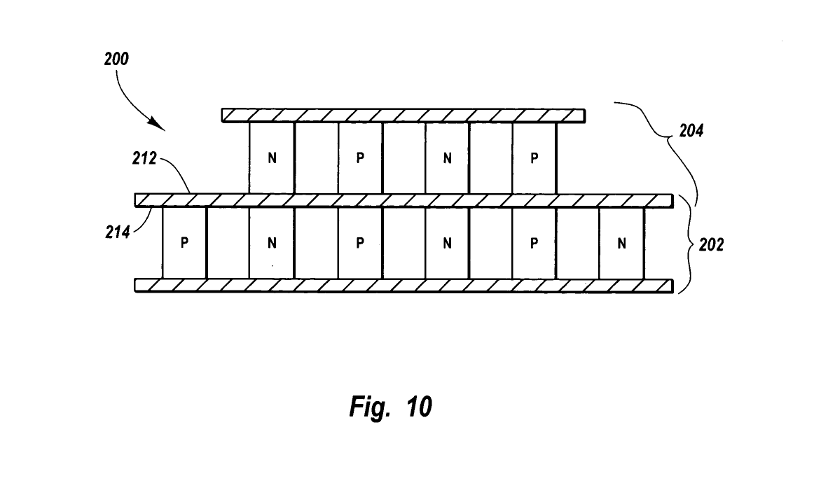

FIG. 10 illustrates a thermoelectric module 200 having a cascade configuration. That is, the thermoelectric module is configured so that one thermoelectric module 204 is stacked on top of another thermoelectric module 202 to place them thermally in series. Thermoelectric modules 202 and 204 share a substrate. This configuration allows higher cooling than is possible with a single thermoelectric module. Generally, the second thermoelectric module 204 has fewer thermoelectric elements than the first thermoelectric module 202.

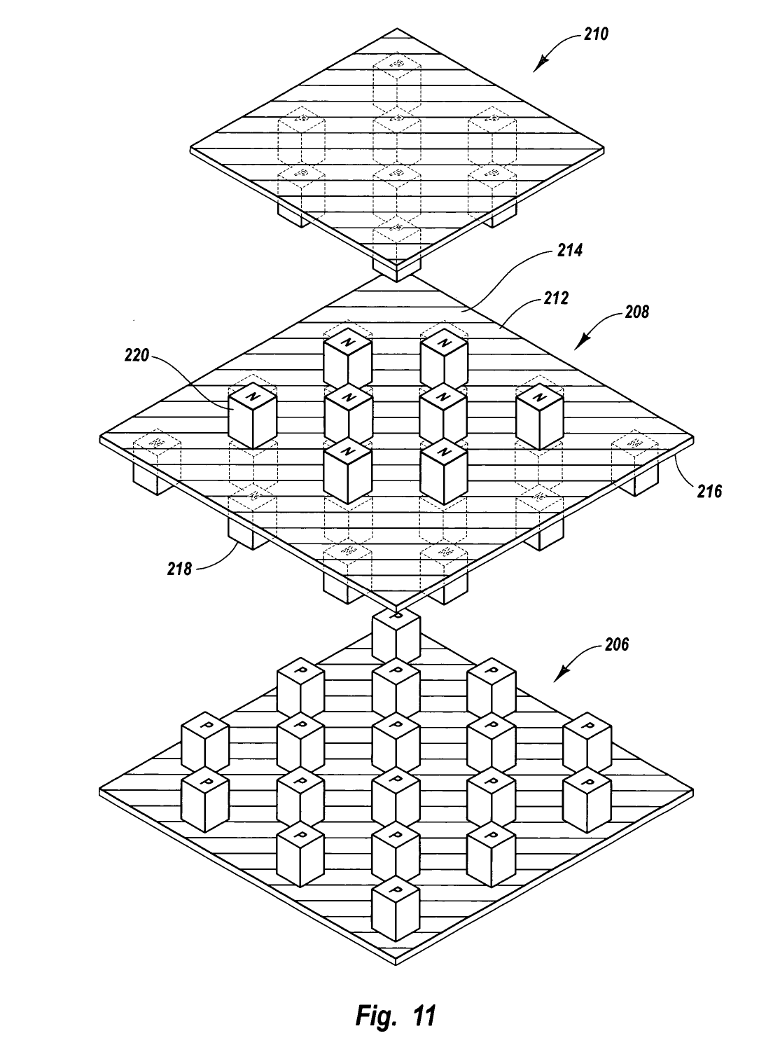

To form the cascade thermoelectric module 200, a first, second and third intermediate structure 206, 208, 210, as illustrated in FIG. 11, are formed using substantially the same steps described above. In particular, the second intermediate structure 208 includes a substrate 212 having a top face 214 and a bottom face 216. The bottom face 216 has formed thereon thermoelectric elements 218 and the top face 214 has thermoelectric elements 220 formed thereon. Advantageously substrate 212 can be used to form both elements 218 and 220 on substrate 212 using steps similar to those outlined with reference to FIGS. 7 through 8.

The thermoelectric material for elements 218, 220 may have the same conductive characteristics or may have different conductive characteristics. That is, in one example, the elements 218 formed on the bottom face 216 may be P-type elements while the elements 220 formed on the top face 218 may be N-type elements. Alternatively, both elements 218 and element 220 could be P-type elements. The elements located on intermediate structures 206, 210 thus contain elements opposite those of the bottom face 216 and top face 214 of intermediate structure 208, respectively.

The first, second, and third intermediate structures 206, 208, 210 are aligned, brought adjacent each other and bonded together using any bonding means known in the art such as brazing or soldering. The metallized pattern ensures that the elements are electrically connected in an appropriate fashion.

After formation of the thermoelectric modules of the present invention, the thermoelectric module can then be mounted to a header, base or heat sink. The thermoelectric modules may also be used in association with other devices such as a laser diode. Methods for mounting the thermoelectric modules of the present invention include compression with a thermal interface pad or thermal grease, solder, brazing, epoxy, and the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for manufacturing a thermoelectric module comprising:
forming a first intermediate structure, the first intermediate structure including a first substrate having a plurality of elements of a first thermoelectric material formed thereon;
forming a second intermediate structure, the second intermediate structure including a second substrate having a plurality of elements of a second thermoelectric material formed thereon, wherein the first thermoelectric material has a different electrical conductivity than the second thermoelectric material;
aligning the first intermediate structure and the second intermediate structure such that the plurality of elements of the first intermediate structure and the plurality of elements of the second intermediate structure are facing each other and positioned in a predetermined arrangement; and
bonding the first intermediate structure to the second intermediate structure.

2. The method as recited in claim 1, wherein forming a first intermediate structure further comprise:
providing a first substrate;
bonding a wafer of a first thermoelectric material to the first substrate; and
removing a portion of the wafer to form a plurality of elements of the first thermoelectric material on the first substrate.

3. The method as recited in claim 1, wherein forming a second intermediate structure further comprise:
providing a second substrate;
bonding a wafer of a second thermoelectric material to the second substrate; and
removing a portion of the wafer to form a plurality of elements of the second thermoelectric material on the second substrate.

4. The method as recited in claim 2, wherein the wafer of a first thermoelectric material comprises bismuth telluride, wherein the wafer is positioned on the first substrate such that the axis of crystal growth is perpendicular to the first substrate.

5. The method as recited in claim 2, wherein providing a first substrate further comprises forming a metallizing pattern on the first substrate.

6. The method as recited in claim 2, wherein removing at least a portion of the wafer to form a plurality of elements of the first thermoelectric material comprises applying one of a dicing technique, a slicing technique, a laser cutting technique, or a combination thereof.

7. The method as recited in claim 1, wherein the first thermoelectric material is N-type bismuth telluride and the second thermoelectric material is P-type bismuth telluride.

8. A method for manufacturing a thermoelectric module comprising:
forming a first intermediate structure comprising:
providing a first substrate;
bonding a first wafer of a thermoelectric material to the first substrate; and
removing a portion of the first wafer to form a plurality of elements on the first substrate; and
forming a second intermediate structure comprising:
providing a second substrate having a top face and a bottom face;
bonding a second wafer of a thermoelectric material to the top face of the second substrate; and
removing a portion of the second wafer to form a plurality of elements on the top face of the second substrate;
wherein the thermoelectric material on the first substrate has a different electrical conductivity than the thermoelectric material on the top face of the second substrate.

9. The method as recited in claim 8, further comprising aligning the first intermediate structure and the second intermediate structure such that the plurality of elements of the first intermediate structure and the plurality of elements of the second intermediate structure are facing each other and positioned in a predetermined arrangement.

10. The method as recited in claim 9, further comprising positioning the plurality of elements of the first intermediate structure adjacent the second substrate and positioning the plurality of elements of the second intermediate structure adjacent the first substrate.

11. The method as recited in claim 10, further comprising bonding the first intermediate structure to the second intermediate structure.

12. The method as recited in claim 8, further comprising:
bonding a third wafer of a thermoelectric material to the bottom surface of the second substrate; and
removing a portion of the third wafer to form a plurality of elements on the bottom surface of the second substrate;

13. The method as recited in claim 12, further comprising forming a third intermediate structure
providing a third substrate;
bonding a fourth wafer of a thermoelectric material to the third substrate; and
removing a portion of the fourth wafer to form a plurality of elements on the third substrate,
wherein the thermoelectric material on the third substrate has a different electrical conductivity than the thermoelectric material on the bottom face of the second substrate.

14. The method as recited in claim 13, further comprising aligning the second intermediate structure and the third intermediate structure such that the plurality of elements on the bottom face of the second intermediate structure and the plurality of elements of the third intermediate structure are facing each other and positioned in a predetermined arrangement.

15. The method as recited in claim 14, further comprising positioning the plurality of elements on the bottom face of the second substrate adjacent the third substrate and positioning the plurality of elements of the third intermediate structure adjacent the bottom face of the second substrate.

16. The method as recited in claim 15, further comprising bonding the second intermediate structure to the third intermediate structure.

17. The method as recited in claim 8, wherein forming a first intermediate structure and forming a second intermediate structure comprises forming a metallizing pattern on the first and second substrate.

18. The method as recited in claim 8, wherein removing a portion of the first wafer and the second wafer comprises applying one of a dicing technique, a slicing technique, a laser cutting technique, or a combination thereof.

19. The method as recited in claim 8, wherein the thermoelectric material of the first intermediate structure and the second intermediate structure are selected from the group consisting of bismuth telluride, lead telluride, ceramic germanium, and bismuth antimony.

20. An intermediate structure for use in manufacturing a thermoelectric module, the intermediate structure comprising:
a substrate;
a metallized pattern formed on the substrate; and
a plurality of thermoelectric elements extending outwardly from the substrate, at least some of the thermoelectric elements being located on the metallized pattern.

21. The intermediate structure as recited in claim 20, wherein the plurality of thermoelectric elements are formed by bonding a wafer of thermoelectric material to the substrate and removing a portion of the wafer, wherein the plurality of thermoelectric elements remains on the substrate.
